(19) United States
(12) Patent Application Publication
(10) Pub. No.: US 2026/0054651 A1
(43) Pub. Date: Feb. 26, 2026

(54) SURROUND VIEW SYSTEM

(71) Applicant: Harman Becker Automotive Systems GmbH, Karlsbad-Ittersbach (DE)

(72) Inventors: Peter Brandt, Pfinztal (DE); Ramazan Ferhat ÖLGÜN, München (DE)

(21) Appl. No.: 19/126,138

(22) PCT Filed: Nov. 29, 2022
(86) PCT No.: PCT/EP2022/083601

§ 371 Date: Apr. 30, 2025

(51) Int. Cl. B60R 1/27; B60R 1/28

(52) U.S. Cl. CPC B60R 1/27; B60R 1/28; B60R 2300/102; B60R 2300/202; B60R 2300/303; B60R 2300/802

(57) ABSTRACT

A surround view system for a vehicle comprises one or more cameras mounted on the vehicle and configured to capture one or more images of a surrounding environment of the vehicle, a driver monitoring unit configured to determine a viewing direction of a driver of the vehicle, and a plurality of holographic projection units arranged at different positions inside the vehicle, wherein each of the plurality of holographic projection units is configured to generate a holographic image on a different one of a plurality of surfaces inside the vehicle, and the surround view system is configured to cause a holographic image to be generated on at least one surface inside the vehicle within the viewing direction determined by the driver monitoring unit, wherein the holographic image is generated based on the one or more images captured by the one or more cameras.

### TECHNICAL FIELD

The disclosure relates to a surround view system, in particular to a surround view system for a vehicle.

### BACKGROUND

Surround view systems in vehicles capture images of a surrounding environment of the vehicle and provide a surround view of the surrounding environment on a display in the vehicle, e.g., a display arranged centrally in a dashboard of the vehicle. Such surround view systems may not always present a perspective of the surrounding environment that is suitable in a specific situation to help the driver to optimally asses a certain situation. The driver may be required to interact with the display (e.g., by means of a touch panel) in order to change the perspective to a suitable perspective. Such interaction, however, may distract the driver and may cause the driver to not be sufficiently focused on a present situation. As a consequence, driver safety may be decreased, and the risk for accidents increased. There is a need for a surround view system and related method that are able to present images of the surrounding environment to the driver of a vehicle without causing unnecessary driver distraction, in order to increase road safety.

### SUMMARY

A surround view system of the present disclosure can be used for a vehicle and includes one or more cameras mounted on the vehicle and configured to capture one or more images of a surrounding environment of the vehicle, a driver monitoring unit configured to determine a viewing direction of a driver of the vehicle, and a plurality of holographic projection units arranged at different positions inside the vehicle, wherein each of the plurality of holographic projection units is configured to generate a holographic image on a different one of a plurality of surfaces inside the vehicle, and the surround view system is configured to cause a holographic image to be generated on at least one surface inside the vehicle within the viewing direction determined by the driver monitoring unit, wherein the holographic image is generated based on the one or more images captured by the one or more cameras.

A method of the present disclosure includes capturing one or more images of a surrounding environment of a vehicle by means of one or more cameras mounted on the vehicle, determining a viewing direction of a driver of the vehicle by means of a driver monitoring unit, and generating a holographic image on a different one of a plurality of surfaces inside the vehicle by means of a plurality of holographic projection units arranged at different positions inside the vehicle, wherein a holographic image is generated on at least one surface inside the vehicle within the viewing direction determined by the driver monitoring unit, wherein the holographic image is generated based on the one or more images captured by the one or more cameras.

Other systems, methods, features and advantages of the present disclosure will be or will become apparent to one with skill in the art upon examination of the following detailed description and figures. It is intended that all such additional systems, methods, features and advantages be included within this description, be within the scope of the invention and be protected by the following claims.

### BRIEF DESCRIPTION OF THE DRAWINGS

The arrangements may be better understood with reference to the following description and drawings. The components in the figures are not necessarily to scale, emphasis instead being placed upon illustrating the principles of the invention. Moreover, in the figures, like referenced numerals designate corresponding parts throughout the different views.

FIG. 1 schematically illustrates a vehicle with a surround view system.

FIG. 2 schematically illustrates a vehicle with a surround view system according to one embodiment of the present disclosure.

FIG. 3 schematically illustrates a vehicle with a surround view system according to another embodiment of the present disclosure.

FIG. 4 schematically illustrates a holographic projection unit arranged in a vehicle.

FIG. 5 schematically illustrates a holographic display unit and an image projected on a windscreen of a vehicle.

FIG. 6 schematically illustrates a holographic display unit according to embodiments of the disclosure in further detail.

FIG. 7 schematically illustrates a method according to an embodiment of the present disclosure.

FIG. 8 schematically illustrates in a flowchart a method according to embodiments of the disclosure.

### DETAILED DESCRIPTION

As required, detailed embodiments of the present invention are disclosed herein; however, it is to be understood that the disclosed embodiments are merely examples of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It is recognized that directional terms that may be noted herein (e.g., “upper”, “lower”, “inner”, “outer”, “top”, “bottom”, etc.) simply refer to the orientation of various components of an arrangement as illustrated in the accompanying figures. Such terms are provided for context and understanding of the disclosed embodiments.

The surround view systems and related methods according to the various embodiments described herein are able to provide a 360° surround view of a surrounding environment to a driver of a vehicle. The surround view system provides a perspective of the surrounding environment that is suitable in most situations to help the driver to asses a certain situation occurring outside of the vehicle. No driver interaction is required for providing an optimal perspective for any specific situation. At the same time, the surround view system does not excessively consume energy.

The surround view systems and related methods according to the various embodiments described herein capture images of a surrounding environment of a vehicle. The captured images are processed and then presented to a driver of the vehicle by projecting the images to respective surfaces of the vehicle. The viewing direction of the driver is determined, and images are (only) projected on such surfaces that lie within the determined viewing direction. If the viewing direction of the driver changes, images of areas of the surrounding environment that are within the changed field of view of the driver are presented on other surfaces of the vehicle, namely on surfaces lying within the changed field of view. That is, it is not necessary to always present the entire surrounding environment to the driver. Only those areas of the surrounding environment that are determined to be relevant to the driver may be presented to the driver, wherein an area of the surrounding environment is determined to be relevant to the driver when it lies within a current field of view of the driver.

Surround view systems according to embodiments of the disclosure are configured to cause holographic images to be generated on one or more surfaces inside the vehicle within the viewing direction (field of view) of the driver determined by a driver monitoring unit, wherein the holographic image is generated based on the one or more images captured by the one or more cameras. If, for example, it is determined that the driver is looking out of the left front side window, a holographic image representing the surrounding environment within this viewing direction is projected on the left front side window. If it is detected that the driver turns their head to look out of the right front side window, a holographic image representing the surrounding environment within this viewing direction is projected on the right front side window. That is, the driver is always presented a 3D holographic image of the surrounding environment of a section of the surrounding environment in the direction they are looking to. In this way, any objects or obstacles within their viewing direction will be presented to the driver. The driver is not required to look at a separate dedicated display, e.g., in the dashboard of the vehicle. The driver, therefore, is not required to mentally transform an image presented on a central display unit with regard to a specific situation. Any objects or obstacles that would otherwise be concealed behind elements of the vehicle, e.g., the doors, pillars, or the hood, may be visualized to the driver. The images that are presented to the user may represent a larger section of the surrounding environment as would otherwise be visible for the driver through the respective windows.

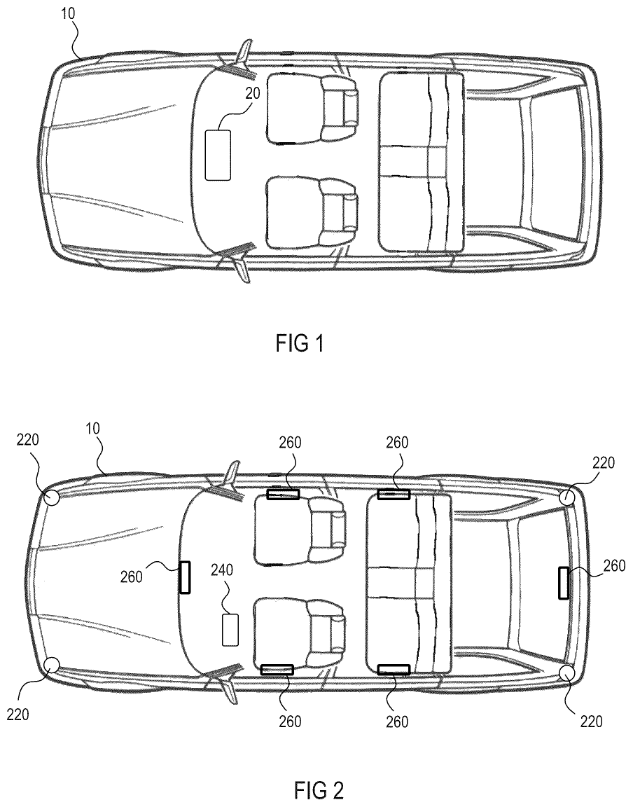

Referring to FIG. 1, a vehicle 10 with a surround view system 20 is schematically illustrated. The surround view system 20 comprises one or more cameras mounted on the vehicle and configured to capture one or more images of a surrounding environment of the vehicle, a driver monitoring unit configured to determine a viewing direction of a driver of the vehicle, and a plurality of holographic projection units arranged at different positions within the vehicle 10. The different elements of the surround view system 20 are not specifically illustrated in FIG. 2. According to one embodiment of the disclosure, the surround view system 20 may comprise a single 360° surround view camera that is arranged, e.g., centrally on the roof of the car, and that is configured to capture 360° images of the surrounding environment of the vehicle 10.

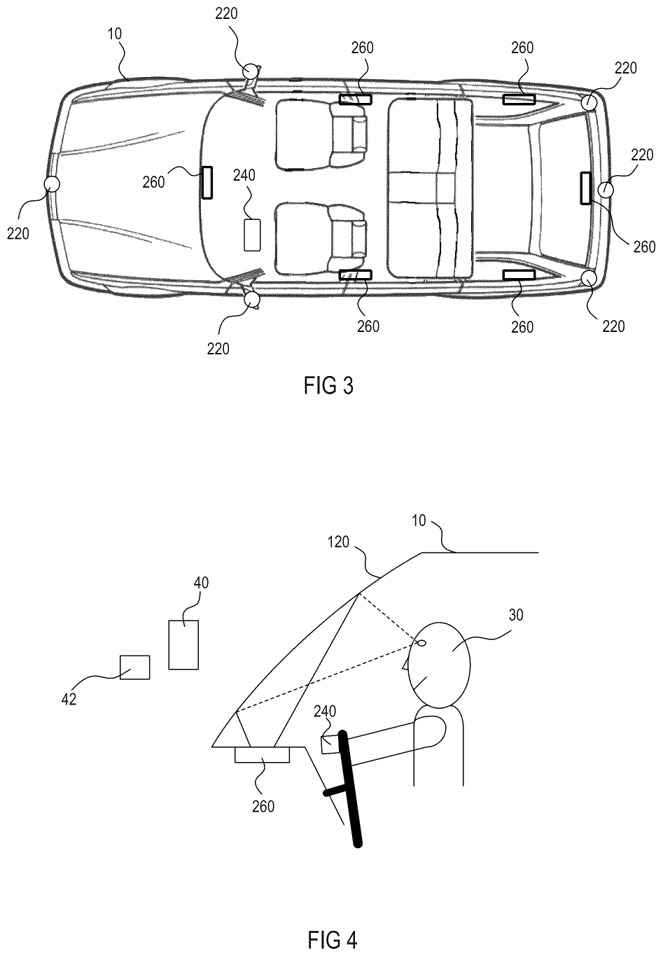

According to other embodiments of the disclosure and as is schematically illustrated in FIGS. 2 and 3, for example, the surround view system 20 may comprise a plurality of cameras 220, wherein each camera 220 is arranged at a different position on the vehicle 10, e.g., on the outside of the vehicle. The one or more cameras 220 are outward facing cameras. In the embodiment as illustrated in FIG. 2, one camera 220 is arranged at each corner of the vehicle 10, for example. In the embodiment illustrated in FIG. 3, one camera 220 is arranged centrally at the front of the vehicle 10, one camera 220 is arranged on or in a first side mirror on the right side of the vehicle 10, one camera 220 is arranged on or in a second side mirror on the left side of the vehicle 10, one camera 220 is arranged at the back left corner, and one camera 220 is arranged at the back right corner of the vehicle 220. Each camera 220 is configured to capture images within a defined viewing angle. This viewing angle may be between 30° and 180°, for example. Angles of even more than 180°, however, are also possible. One or more of a plurality of cameras 220 may be spherical cameras, for example, that are configured to capture 360° images. In this way, images of the entire surrounding environment may be captured by means of the one or more cameras 220. The positions of the cameras 220 as schematically illustrated in FIGS. 2 and 3, however, are only examples. It is generally possible to arrange the one or more cameras 220 at any suitable positions.

Using one or more spherical cameras 220, for example, allows to provide a 3D stereo reconstruction of the surrounding environment captured in the images to a driver of the vehicle. Each of a plurality of cameras 220 may capture one or more 2D images that are subsequently processed and stitched together in suitable ways in order to provide 3D depth holographic images to the driver of the vehicle 10.

The one or more cameras 220 may be static. That is, each camera 220 may be configured to capture a defined section of the surrounding environment. It is, however, also possible that one or more of the one or more cameras 220 may be pivotable cameras such that a different section of the surrounding environment may be captured, depending on the orientation of the camera 220.

The driver monitoring unit 240 is configured to determine a viewing direction of a driver of the vehicle 10. That is, the driver monitoring unit 240 determines whether the driver is looking ahead out of the windshield of the vehicle 10, out of a side window, out of the rear window or in any other direction. The driver monitoring unit 240 may comprise one or more cameras (e.g., inward facing cameras), and may determine the viewing direction of the driver by means of facial recognition or eye tracking techniques, for example. The driver monitoring unit 240 may be arranged at or close to the steering wheel of the vehicle 10, for example, as is schematically illustrated in FIGS. 2 and 3. The driver monitoring unit 240, however, may be arranged in any other suitable position in the vehicle 10. It is also possible that the driver monitoring unit 240 comprises a plurality of inward facing cameras arranged at different positions inside the vehicle 10. In this way, there is always at least one camera that captures the face of the driver in order to be able to clearly determine their viewing direction. The viewing direction of the driver, however, can also be determined in any other suitable way.

The surround view system 20 further comprises a plurality of holographic projection units 260 arranged at different positions within the vehicle 10. Each of the plurality of holographic projection units 260 is configured to generate a holographic image on a different one of a plurality of surfaces inside the vehicle 10. In the embodiment illustrated in FIG. 2, for example, the surround view system 20 comprises a different holographic projection unit 260 for each of a windscreen, a rear window as well as for each of the front side windows and each of the rear side windows. That is, each of the holographic projection units 260 is arranged at a different position and projects a holographic image on a different one of the windows of the vehicle 10. The positions of the holographic projections units 260 as illustrated in FIG. 2, however, are only examples.

Holographic projection units 260 arranged at different positions are schematically illustrated in FIG. 3. In the embodiment illustrated in FIG. 3, a holographic projection unit 260 projects a holographic image on the windscreen, another holographic projection unit 260 projects a holographic image on the rear window, one holographic projection unit 260 projects a holographic image on both the left front and rear side windows, and an even further holographic projection unit projects a holographic image on both the right front and rear side windows. Even further holographic projection units 260 are arranged to project holographic images on left and right side windows behind the back seats in the area of the trunk of the vehicle 10. Any other number of holographic projection units 260 and any other suitable positions are generally possible. The windows of a vehicle are not entirely transparent and are therefore suitable to function as projection screens for the holographic images. The windows, however, may also be coated with respective reflective foils, for example. The light that is emitted by the holographic projection units 260 is partly reflected by the respective window (or surface). The reflected light is perceived by the driver of the vehicle. Similar to conventional mirrors, the image, due to the reflection, is perceived as a three-dimensional image positioned behind the reflective surface. Holographic images may be at least partly projected on other surfaces than the windows as well such as, e.g., on the pillars of the vehicle between the different windows. Such surfaces may be covered with a reflective material, e.g., a reflective foil, on which the images can be projected. In this way, a full 360° view of the surrounding environment can be presented to the driver without any disruptions.

A holographic image projected on the rear window can be observed by the driver of the vehicle by directly looking in the direction of the rear window. It is, however, also possible that an image is projected on the rear window when the driver is looking into the rear view mirror. Images projected on the rear window are reflected in the rear view mirror and are therefore also visible for the driver in the rear view mirror.

It is generally possible that a full 360° surround view is presented to the driver. That is, images of the surrounding environment may be projected simultaneously on all of the windows of the vehicle, and optionally on any additional surfaces, e.g., between the windows. This, however, requires a significant amount of power. In order to keep power consumption at a minimum, images may only be presented on those windows and, optionally, other surfaces that lie within the viewing direction of the driver as determined by the driver monitoring unit 240.

Similarly, it is possible that all of the one or more cameras 220 are active at the same time to capture images of the entire surrounding environment. It is, however, also possible to activate only such cameras that are positioned to capture images of sections of the surrounding environment lying within the field of view of the driver as determined by the driver monitoring unit 240. This may reduce the power consumption of the surround view system even further.

A holographic projection unit 260 according to embodiments of the disclosure is schematically illustrated in FIG. 4. The holographic projection unit 260 is arranged below the windscreen 120 and is configured to project holographic images on the windscreen 120. The windscreen acts as a reflective hologram surface RHS that, when illuminated by a light source, reflects a 3D hologram. The hologram reflected by the RHS is visible in a virtual free programmable distance outside of the vehicle. This is schematically illustrated for two objects 40, 42 in FIG. 4. The distance of the RHS and the objects 40, 42 as perceived by the driver of the vehicle 10 may be adjusted by means of suitable software, for example. Different objects may be perceived at different distances with regard to the RHS, as is schematically illustrated for the objects 40, 42 in FIG. 4. The objects 40, 42 are perceived by the driver 30 as being three-dimensional. That is, if the driver 30 moves his head and views the objects 40, 42 from a different viewing angle, they perceive the objects 40, 42 under a different angle, as is the case with real objects. The objects 40, 42 may be perceived as flat objects or the objects 40, 42 may have a defined virtual thickness. The eyes of the driver 30 may register two different images, each of the two images representing one of the two objects 40, 42. The brain, however, blends these two images to a single image. The driver 30, therefore, perceives a single image in which any objects that are present outside of the vehicle 10 are illustrated at respective distances with respect to the vehicle 10 and with respect to each other.

An image as projected on a windscreen 120 of the vehicle 10 and as perceived by the driver 30 is schematically illustrated in FIG. 5. The image is a three-dimensional image representing the surrounding environment of the vehicle in the viewing direction of the driver 30 (out of the windscreen in the example of FIG. 5). In this way, any objects within the viewing direction of the driver 30 are made visible for the driver. This includes objects the driver would be able to see through the respective window without the projection (e.g., the house and the tree), as well as any objects that might otherwise be concealed behind elements of the vehicle 10 (e.g., the tricycle), e.g., behind the doors, pillars, or the hood.

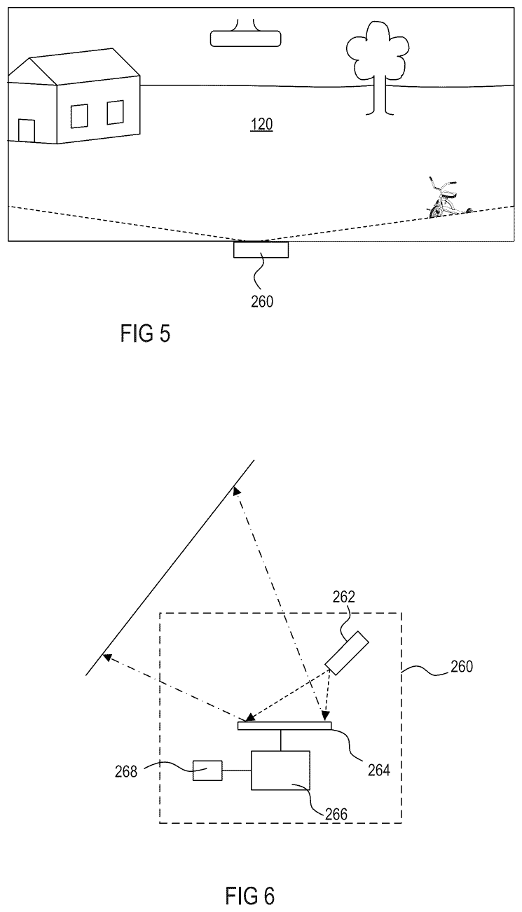

Now referring to FIG. 6, a holographic projection unit 260 according to embodiments of the disclosure is illustrated in greater detail. A holographic projection unit 260 may comprise a light source 262, an adjustable diffractive unit 264, a control unit 266, and a data processing unit 268, for example. The light source 262 may be a brightness controllable light source. The brightness of the projection may be adapted based on environmental conditions. For example, two different designs may be possible such as a night design and a day design. The day design may be used during the day when it is bright outside and inside of the vehicle. The holographic projection unit 260 may be configured to change from the day design to the night design when the brightness outside and/or inside of the vehicle is detected to be below a defined threshold value. It is, however, also possible to implement one or more intermediate stages in which the projection is dimmed to different degrees.

The diffractive unit 264 deflects light from the light source 262 onto a reflective hologram surface RHS (e.g., a window of the vehicle 10, or any other suitable surface of the vehicle 10) and into the visual range of the driver 30. In particular, when illuminated by the light source 262 via the diffractive unit 264, the RHS reflects a three-dimensional hologram in a visual range in a desired direction, e.g., in a direction of the driver 30 of the vehicle 10. The driver 30 perceives a fringe pattern caused by a pattern of the diffractive unit 264. The fringe pattern corresponds to the reconstructed hologram and the projected elements 40, 42.

According to one embodiment of the disclosure, the diffractive unit 264 comprises a plurality of phase retarding elements, wherein each of the plurality of phase retarding elements delays the phase of light reflected or transmitted by a defined amount. The defined amount of this phase delay may be individually controlled for each phase retarding element by means of the control unit 266. Any hologram imprinting a specific phase pattern into light of the light source 262 for generating the reconstructed hologram can be implemented in this or in similar ways. The control unit 266 is configured to provide different control patterns to generate different holograms via the diffractive unit 264. A plurality of different control patterns may be generated or stored in the data processing unit 268. Based on the images to be displayed by the holographic projection unit 260, the data processing unit 268 may select one or more pre-calculated control patterns for respective holograms. The holographic projection unit 260 as illustrated in FIG. 6 and as has been described above, however, is only an example. A holographic projection unit 260 can be implemented in any other suitable way in order to generate a three-dimensional scene beyond a two-dimensional RHS.

The surround view system 20 may be permanently active after the ignition has been switched on until the ignition is switched off again. It is, however, also possible that the surround view system 20 is active only in defined situations. For example, the surround view system 20 may be activated when a driver 30 performs a parking process, when the vehicle 10 is determined to drive in a narrow and/or complex surrounding environment, or when the vehicle 10 is driving below or above a defined threshold velocity. It is also possible that the surround view system 20 is activated in any other situations in which the projection of images of the surrounding environment is considered to increase driver safety.

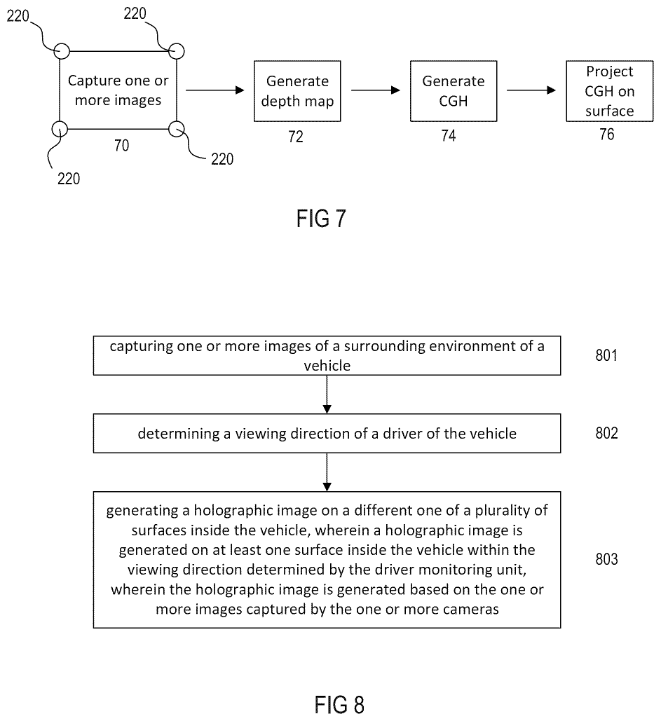

Now referring to FIG. 7, a method according to embodiments of the present disclosure is schematically illustrated. In a first stage, one or more images may be captured by means of one or more cameras 220, wherein at least a section of a surrounding environment of a vehicle 10 is captured in each of the one or more images (step 70). The one or more cameras 220 may be spherical cameras and the one or more images captured by the one or more cameras may represent a stereoscopic view of the surrounding environment of the vehicle 10. In a subsequent step, a depth map may be generated from the stereoscopic view as represented by the one or more images (step 72). From this depth map, a computer generated hologram CGH may be generated (step 74) and projected on respective surfaces within the vehicle 10 (step 76). It is generally possible to generate a three-dimensional depth map from two-dimensional input images, e.g., by means of stereoscopic image rectification. This allows to estimate a distance of different objects and/or road users with respect to each other and with respect to the vehicle 10. Such techniques are generally known and will not be discussed in further detail herein. The determined three-dimensional depth maps may then be visualized by means of computer generated holograms CGH. A multicolor holographic image can be decoupled in the far field by means of a binary metasurface computer generated hologram CGH without using any lenses, for example. Such a technology enables lens-free, ultraminiature augmented and virtual reality displays.

Now referring to FIG. 8, a method according to embodiments of the disclosure is schematically illustrated. The method comprises capturing one or more images of a surrounding environment of a vehicle 10 by means of one or more cameras 220 mounted on the vehicle 10 (Step 801), determining a viewing direction of a driver 30 of the vehicle 10 by means of a driver monitoring unit 240 (step 802), and generating a holographic image on a different one of a plurality of surfaces inside the vehicle 10 by means of a plurality of holographic projection units 260 arranged at different positions inside the vehicle 10 (step 803), wherein a holographic image is generated on at least one surface inside the vehicle 10 within the viewing direction determined by the driver monitoring unit 240, wherein the holographic image is generated based on the one or more images captured by the one or more cameras 220.

The description of embodiments has been presented for purposes of illustration and description. Suitable modifications and variations to the embodiments may be performed in light of the above description or may be acquired from practicing the methods. The described arrangements are exemplary in nature, and may include additional elements and/or omit elements. As used in this application, an element recited in the singular and proceeded with the word “a” or “an” should not be understood as excluding the plural of said elements, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The described systems are exemplary in nature, and may include additional elements and/or omit elements. The subject matter of the present disclosure includes all novel and non-obvious combinations and sub-combinations of the various systems and configurations, and other features, functions, and/or properties disclosed. The following claims particularly disclose subject matter from the above description that is regarded to be novel and non-obvious.

1. A surround view system for a vehicle comprises:
one or more cameras mounted on the vehicle and configured to capture one or more images of a surrounding environment of the vehicle;
a driver monitoring unit configured to determine a viewing direction of a driver of the vehicle; and
a plurality of holographic projection units arranged at different positions inside the vehicle, wherein
each of the plurality of holographic projection units is configured to generate a holographic image on a different one of a plurality of surfaces inside the vehicle, and
the surround view system is configured to cause a holographic image to be generated on at least one surface inside the vehicle within the viewing direction determined by the driver monitoring unit, wherein the holographic image is generated based on the one or more images captured by the one or more cameras.

2. The surround view system of claim 1, wherein the holographic image that is generated on the at least one surface inside the vehicle represents a section of the surrounding environment within the viewing direction of the driver.

3. The surround view system of claim 1, wherein the at least one surface comprises one or more of a windscreen, a left front side window, a right front side window, a left rear side window, a right rear side window, and a rear window.

4. The surround view system of claim 3, wherein the at least one surface further comprises one or more pillars of the vehicle.

5. The surround view system of claim 4, wherein the pillars are covered with a reflective material.

6. The surround view system of claim 1, wherein each of the one or more cameras has a viewing angle of between 30° and 180°, or of more than 180°.

7. The surround view system of claim 1, wherein at least one of the one or more cameras is a spherical camera that is configured to capture 360° images.

8. The surround view system of claim 1, wherein the driver monitoring unit comprises one or more inward facing cameras.

9. The surround view system of claim 1, wherein the driver monitoring unit is configured to determine the viewing direction of the driver by means of facial recognition or eye tracking techniques.

10. The surround view system of claim 1, wherein each of the plurality of holographic projection units comprises a light source, an adjustable diffractive unit, a control unit, and a data processing unit, wherein
the light source is configured to illuminate the adjustable diffractive unit,
the adjustable diffractive unit deflects light from the light source onto the at least one surface and into the visual range of the driver,
the control unit is configured to provide different control patterns to generate different holograms via the diffractive unit, and
the data processing unit is configured to generate or store a plurality of different control patterns, and to select one or more pre-calculated control patterns for respective holograms based on the image to be displayed by the holographic projection unit.

11. The surround view system of claim 10, wherein the light source is a brightness controllable light source.

12. The surround view system of claim 10, wherein the diffractive unit comprises a plurality of phase retarding elements, wherein each of the plurality of phase retarding elements delays the phase of light reflected or transmitted by a defined amount.

13. The surround view system of claim 12, wherein the defined amount of phase delay is individually controlled for each phase retarding element by means of the control unit.

14. A method comprising
capturing one or more images of a surrounding environment of a vehicle by means of one or more cameras mounted on the vehicle;
determining a viewing direction of a driver of the vehicle by means of a driver monitoring unit; and
generating a holographic image on a different one of a plurality of surfaces inside the vehicle by means of a plurality of holographic projection units arranged at different positions inside the vehicle, wherein
a holographic image is generated on at least one surface inside the vehicle within the viewing direction determined by the driver monitoring unit, wherein the holographic image is generated based on the one or more images captured by the one or more cameras.
